(19) United States
(12) Patent Application Publication
(10) Pub. No.: US 2016/0253636 A1
(43) Pub. Date: Sep. 1, 2016

(54) RECYCLING KIOSK

(71) Applicant: Count & Crush Systems, LLC, South Portland, ME (US)

(72) Inventors: George C. Kyle, JR., Freeport, ME (US); George A. Mayo, Scarborough, ME (US)

(73) Assignee: Count & Crush Systems, LLC, South Portland, ME (US)

(21) Appl. No.: 15/148,835

(22) Filed: May 6, 2016

Related U.S. Application Data
(63) Continuation of application No. 13/886,579, filed on May 3, 2013, now abandoned.
(60) Provisional application No. 61/642,696, filed on May 4, 2012.

(51) Int. Cl. G06Q 10/00; G06Q 30/02

(52) U.S. Cl. CPC G06Q 10/30; G06Q 30/0237

(57) ABSTRACT

Methods, systems and apparatus for administering a recycling program having one or more vendor participants. An exemplary method involves electronically receiving an indication of a quantity of recycled goods corresponding to at least one of the one or more vendor participants, calculating a coupon value applicable to the purchase of new goods from at least one of the one or more vendor participants based at least in part on the indication, and electronically transmitting and/or electronically storing the coupon value to provide the coupon value to a consumer as a reward for providing the recycled goods.

### RELATED APPLICATIONS

This application is a continuation, claiming the benefit under 35 U.S.C. §120, of U.S. application Ser. No. 13/886,579 entitled “VENDOR-BASED RECYCLING PROGRAM,” filed May 3, 2013 under Attorney Docket No. E0406.70008US01, which claims the benefit under 35 U.S.C. §119(e) of U.S. Provisional Patent Application Ser. No. 61/642,696 entitled “VENDOR-BASED RECYCLING PROGRAM,” filed on May 4, 2012 under Attorney Docket No. E0406.70008US00, each of which is hereby incorporated herein by reference in its entirety.

### BACKGROUND

Recycling programs exist that provide consumers value in exchange for recycled containers. Many of these programs rely on legislation that requires beverage containers to carry a refundable deposit to encourage recycling (so-called “bottle bills”). One such recycling program is discussed in commonly-owned U.S. patent application Ser. No. 11/725,698, published as U.S. Patent Publication No. 2007/0276686 (hereafter “the '686 publication”), which is hereby incorporated by reference herein in its entirety. Many states, however, do not have bottle bills and many municipalities have no system for collecting recyclable materials at or near individual residences. In such states, it can be difficult to motivate consumers to recycle.

### SUMMARY

Various embodiments described herein are directed to methods, apparatus and systems for administering a vendor-based recycling program. The recycling program may motivate consumers to recycle goods, for example even in the absence of a bottle bill-mandated refundable deposit or convenient municipal collection system.

One embodiment described herein is directed to a method for administering a recycling program having one or more vendor participants. The method comprises: electronically receiving an indication of a quantity of recycled goods corresponding to at least one of the one or more vendor participants; based at least in part on the indication, calculating, using at least one processor, a coupon value applicable to the purchase of new goods from at least one of the one or more vendor participants; and electronically transmitting and/or electronically storing the coupon value to provide the coupon value to a consumer for providing the recycled goods.

Another embodiment described herein is directed to at least one computer-readable storage medium encoded with instructions that, when executed by at least one processing unit, cause performance of a method for administering a recycling program having one or more vendor participants. The method comprises: electronically receiving an indication of a quantity of recycled goods corresponding to at least one of the one or more vendor participants; based at least in part on the indication, calculating a coupon value applicable to the purchase of new goods from at least one of the one or more vendor participants; and electronically transmitting and/or electronically storing the coupon value to provide the coupon value to a consumer for providing the recycled goods.

A further embodiment described herein is directed to an apparatus for administering a recycling program having one or more vendor participants, the apparatus comprising: a communication interface; a memory to store processor-executable instructions; and a processing unit communicatively coupled to the communication interface and the memory. Upon execution of the processor-executable instructions by the processing unit, the processing unit: controls the communication interface to electronically receive an indication of a quantity of recycled goods corresponding to at least one of the one or more vendor participants; based at least in part on the indication, calculates a coupon value applicable to the purchase of new goods from at least one of the one or more vendor participants; and further controls the communication interface and/or the memory to electronically transmit and/or electronically store the coupon value to provide the coupon value to a consumer for providing the recycled goods.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 is a diagram depicting the operation of an exemplary vendor-based recycling program;

FIG. 2 shows an exemplary interface that may be viewed by a consumer at a kiosk, a computing device, or the like;

FIG. 3 shows an exemplary interface for an organization; and

FIG. 4 shows an exemplary implementation of the kiosk shown in FIG. 1.

FIG. 5 is a block diagram depicting an exemplary computer system which may be implemented according to one or more aspects of the present application.

### DETAILED DESCRIPTION

To address the difficulty in motivating consumers in non-bottle bill states to recycle, a vendor-based recycling program has been developed and is described herein, according to some aspects. According to this program, vendors such as soft drink manufacturers, beer manufacturers and consumer product manufacturers, among other possibilities, may elect to have their goods be recyclable via the recycling program. To incentivize the consumers to recycle the goods (e.g., containers or consumables) that are part of the program, the vendors agree that coupons of a value corresponding to an amount (e.g., a weight or a number) of recycled goods are provided in exchange for the receipt of those goods.

### Overview of Exemplary Vendor-Based Recycling Program

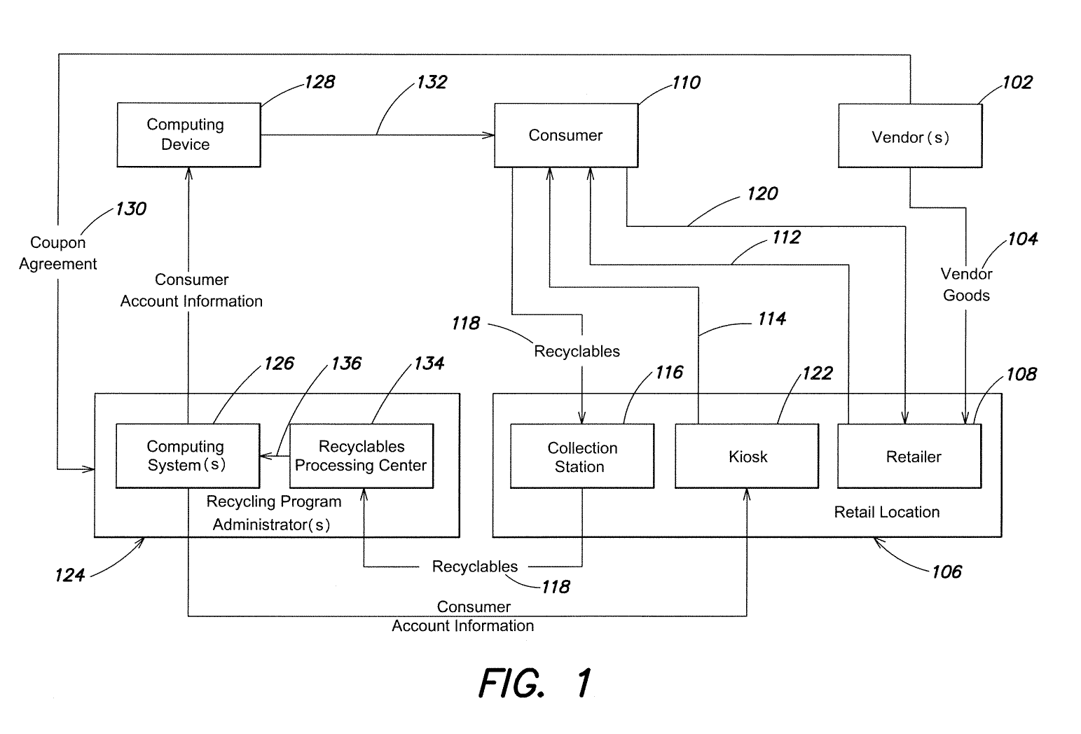

FIG. 1 is a diagram depicting the operation of an exemplary vendor-based recycling program. The vendor(s) 102 provide products (also referred to herein as “vendor goods”) 104 that are sold at at least one retail location 106 (e.g., a chain of discount department stores, warehouse stores, or grocery stores) by a retailer 108 to a consumer 110 as shown by arrow 112. As described previously, the vendor(s) 102 agree that certain vendor goods 104, which may include a container and/or the consumable itself, are recyclable via the recycling program. The vendor(s) 102 also agree to provide value, for example in the form of a coupon 114 having a coupon amount, in exchange for products being recycled using the recycling program, for example when a consumer provides recyclables 118 to a collection station 116 or otherwise for recycling. In some embodiments, the collection station 116 may be part of the retail location 106, though not all embodiments are limited in this respect. In some embodiments, the retail location 106 may include a kiosk 122 which may be used, for example, to provide the coupon 114 to the consumer 110.

The consumer 110, or another consumer, may use such coupons at the retail location 106 (or another retail location) by providing them to the retailer 108, as indicated by arrow 120.

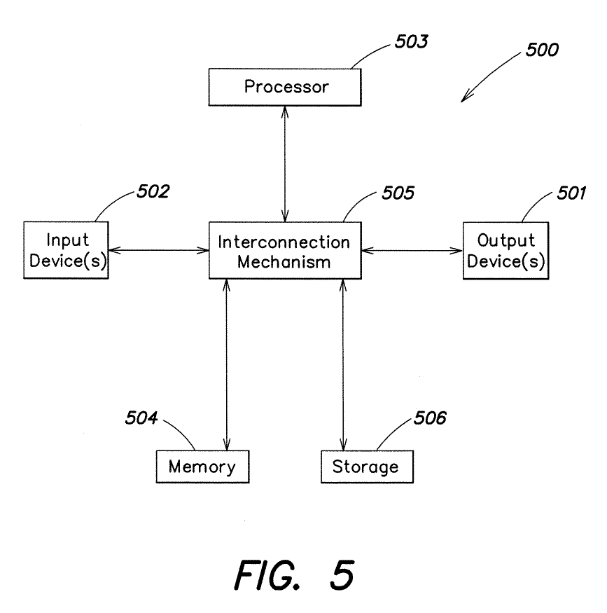

Recycling program administrator(s) 124 administer the recycling program and provide an interface between the consumer 110, vendor(s) 102 and retailer 108. The recycling program administrator(s) 124 may maintain one or more computing systems 126. The computing system(s) 126 may store consumer information and recycling transaction information. Such information may be logically linked in memory so that particular recycling transactions can be identified as corresponding to a particular consumer account. The computing systems may comprise at least one memory (e.g., a database) and at least one processor. An exemplary implementation of the memory is described in the '686 publication in connection with FIG. 5, which shows an exemplary manner of storing information in a consumer database 112 of that publication. As also described in the '686 publication, information pertaining to the consumer's account and transactions may be made available at a kiosk (e.g., kiosk 122 in FIG. 1 of the present application), which may be implemented in a manner similar to kiosk 102 described in the '686 publication or may be made available via a computing device 128. The computing device may be a personal digital assistant (PDA), smart phone or other cellular phone, personal computer or the like. The computing system(s) 126 may transmit information (e.g., consumer account information) to and receive information from the computing device 128 and kiosk 122 via a communication interface, which may be a wired and/or wireless communication interface for connecting to a network and by which information may be exchanged.

The computing system(s) 126 may be configured to determine coupons or coupon values to be made accessible to the consumer 110. In particular, the computing systems may base a coupon value on transactions in the database for which value has not already been provided to the consumer. For example, the computing systems may determine that the consumer has submitted 10 pounds of recyclables that are eligible for the recycling program and for which value (e.g., a coupon) has not yet been redeemed. The computing system may determine a coupon value based on this weight and a coupon agreement 130 with one or more of the vendor(s). If a vendor agrees to provide a coupon value of $0.10 per pound of recycled material, the computing system would determine that a $1.00 coupon should be made accessible to the consumer. A number of variations on this method of calculating value are possible. For example, the value may be based on a number of containers or products received, rather than on a weight of recyclables received. Further, the value provided may differ based on the type of recyclables received (e.g., plastic, aluminum, green glass, clear glass, particular vendor products or the like). The coupon value may be limited to use for the purchase of goods that are eligible for the recycling program. Further, the coupon value may be limited to use at the retail location and/or an affiliated retail location (e.g., another store in the same chain). It should be appreciated that coupons may refer to monetary discounts, percentage discounts, offers for free or discounted goods, or other incentives to purchase or recycle.

The coupon or coupon value may be made available to the consumer 110 in any of various ways. For example, the coupon may be printable at the kiosk 122 at the retail location 106 or by a consumer 110 via the computing device 128 as shown by arrow 132 which may represent the transfer of information and/or coupons from the computing device 128 to the consumer 110. With respect to the computing device 128, the consumer may print a coupon made accessible on a web site administered by the recycling program administrator(s) 124 or print an e-mail sent by the recycling program administrator(s) 124 that includes the coupon. However, the coupon need not assume a paper form. For example, the coupon could comprise a bar code or other code that is displayable on the computing device and scannable at the retail location. As yet another exemplary alternative, the coupon value could be transferred to a retailer rewards card or another scannable device, for example via a transaction at the kiosk 122. Numerous other alternative embodiments of the coupon and/or coupon value are possible, and the above-provided examples are not intended to be limiting.

The recycling program administrator(s) 124 may also administer a recyclables processing center 134, which may sort recycled goods (e.g., recyclables 118 received from the collection station 116) and/or determine a weight, number and/or type of recycled goods submitted by particular consumers. An exemplary recyclables processing center is described in the '686 publication, i.e., the container processing facility 106 in the '686 publication. The '686 publication describes the container processing facility 106 determining a deposit amount corresponding to a container. However, this is not a requirement of the recyclables processing center shown in FIG. 1 of the present application since value may be provided to the consumer 110 based on a weight, number and/or type of recyclables submitted, independent of whether the recyclables are eligible for deposit redemption. The recyclables processing center 134 may provide information on consumers and/or recyclables to computing system 126, as indicated by arrow 136.

As described, the retail location 106 may include a collection station 116 where recyclable vendor goods (also referred to herein as “recyclables”) 118 are deposited. For example, the collection station 116 may be a self-service drop-off center located, for example, in a parking lot or entrance area of the retailer 108. The recyclable vendor goods 118 may be deposited in one or more bags or other receptacles that include a consumer identifier to identify the goods as being received from or on behalf of a particular consumer 110. The collection station 116 may, according to one exemplary implementation, comprise a locked receptacle (e.g., a dumpster or other storage bin) that may be accessed by scanning a consumer tag or related consumer identifier. Alternatively or additionally, the collection station may comprise a mechanism (e.g., a one-way door) that allows the deposit, but not the removal, of recyclables. As yet another alternative, the collection station 116 may be staffed to ensure the security of recyclables.

### Recyclable Goods in Program

As referred to herein, a recyclable “good” may refer to a container (e.g., a bottle, can, box, clamshell, jug or the like), a consumable (e.g., toothbrush, cup, bowl, plate or the like), and/or any portion or combination of the container and/or consumable. The goods may be made of any of a variety of materials, including aluminum, plastic (e.g., PET), cardboard, paper and glass.

One potential difficulty in administering the vendor-based recycling program described in connection with FIG. 1 is that it may be unclear to consumers which goods are eligible for the recycling program. For example, although a consumer may have access to a list of vendors that participate in the recycling program or particular vendor goods that are eligible for the program, the consumer may not recall the details of the list while shopping at the retailer. Further, even if the consumer does recall what goods and/or vendors are eligible, he or she may not be focused on that information while shopping. To address such potential difficulties, recyclable goods may comprise an indication that they are eligible for the vendor-based recycling program. For example, a recyclable good may include a symbol, logo, or name corresponding to the recycling program. Additionally or alternatively, the recyclable good may have a color, shape, form or design indicating that it is eligible for the recycling program. Such indicia may facilitate a consumer recognizing the goods as eligible for the recycling program, which may motivate the consumer to purchase those goods.

Another potential difficulty in administering the vendor-based recycling program described in connection with FIG. 1 is that recyclable goods may belong to categories that are preferably separated by a consumer prior to deposit at the collection station, and the consumer may have difficulty recognizing which goods belong to which categories. For example, aluminum cans and polyethylene terephthalate (PET) bottles need not be separated from each other by the consumer, as they are readily separated at the recyclables processing center, although they may be separated in some embodiments. However, cardboard containers may be preferably kept separate from aluminum cans and PET bottles, because comingling the receptacles may contaminate the aluminum/PET or cardboard in a manner that degrades its value. To address such potential difficulties, recyclable goods may comprise an indication of how they should be sorted for a recycling program. For example, recyclable goods may include a symbol, logo, color or the like that corresponds to a symbol, logo or color on the administrator-provided recycling receptacles (e.g., bags).

As a more specific example, a recyclable good may include a green recycling program logo. The logo itself may indicate that the good is eligible for the recycling program. The green color of the logo may indicate that the good belongs to a category that should be recycled using green recycling receptacles that are provided by the administrator for the purpose of recycling and keeping separate that category of goods. According to an exemplary implementation, the green receptacles may be provided for recycling cardboard goods, while receptacles of another color (e.g., blue) may be provided for recycling aluminum cans and/or PET bottles. As this example illustrates, indicia provided on recyclable goods may indicate to a user that the goods are eligible for a recycling program and/or how the goods should be sorted in a readily identifiable, straightforward, user-friendly manner.

The recyclable goods may be made from 100% recycled materials and/or designed to be 100% recyclable, sometimes referred to as “cradle-to-cradle” goods since the recycled goods become feedstock for new goods. Further, either or both of these qualities may be a requirement for goods in the recycling program. The recycling program may be designed so that the goods are 100% recyclable without any loss or any significant loss in quality and/or purity. For example, the quality and/or purity of cardboard may diminish if comingled with other goods. Thus, the recycling program may be designed so that cardboard goods are separated by the consumer and kept separate during the recycling process, e.g., using an indicia on cardboard goods and separate recycling receptacle for cardboard goods as discussed above.

### Electronic Interface

The recycling program may have an associated electronic interface (e.g., web site or kiosk interface) that allows consumer participants (e.g., consumer 110 of FIG. 1) to view account balances, view and print coupons (e.g., coupons 114) themselves and/or view the environmental impact of the consumer's recycling efforts. As referred to herein, the “consumer” 110 may refer to an individual or organization (e.g., company, school, church, community organization or charitable organization) who has an account associated with the recycling program. In some cases, the consumer 110 may refer to an individual who does not have an account, but purchases and/or recycles goods in the recycling program (e.g., to benefit a particular account holder).

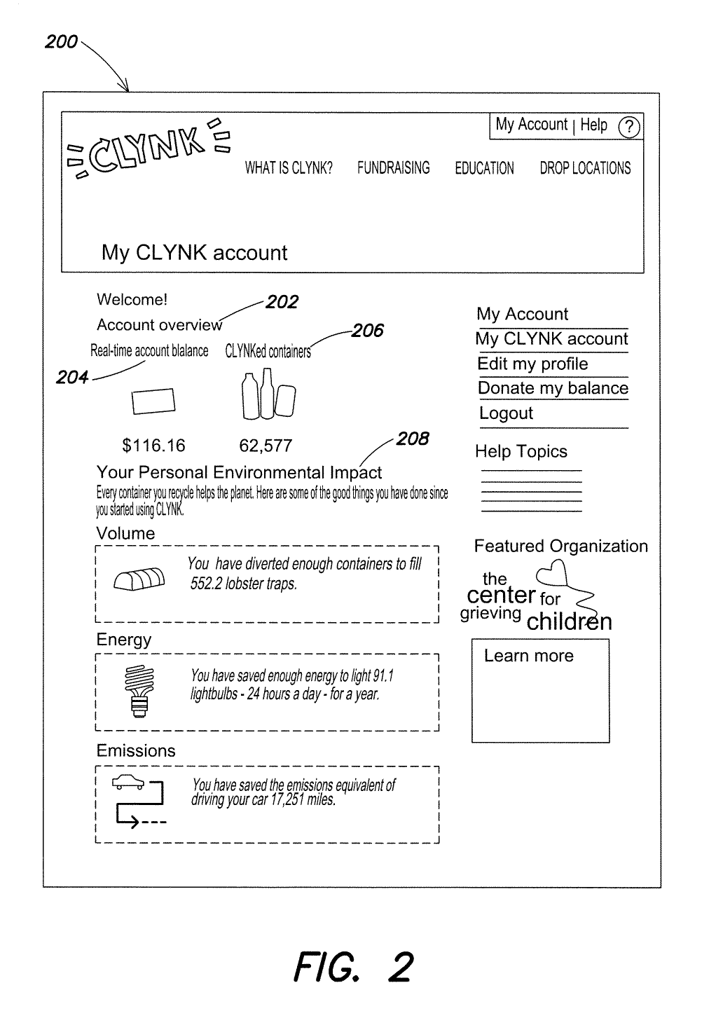

FIG. 2 shows an exemplary interface 200 that may be viewed by a consumer at a kiosk (e.g., kiosk 122), on computing device (e.g., computing device 128), or the like. The interface 200 includes an account overview section 202 that shows the consumer's real-time account balance 204 and number of recycled containers 206. The interface also includes an environmental impact section 208 that shows the environmental impact of the consumer's recycling efforts in terms of volume, energy and emissions.

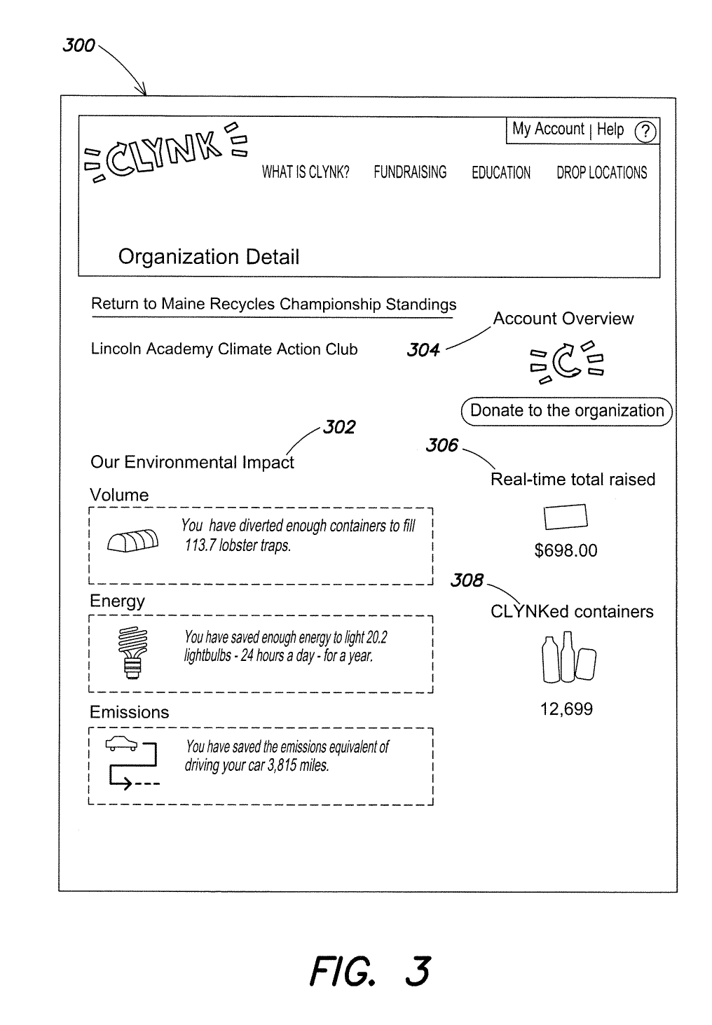

FIG. 3 shows an exemplary interface 300 for an organization. The interface 300 includes an environmental impact section 302 as discussed above, which shows the environmental impact of the organization's recycling efforts in terms of volume, energy and emissions. The organization's recycling efforts may reflect the efforts of a number of individuals who recycle goods on behalf of the organization (e.g., using the organization's account identifier on recycling receptacles returned to the collection station). The interface 300 includes an account overview section 304 that shows the organization's real-time account balance 306 (shown in the figure as “Real-time total raised”) and number of recycled containers 308.

### Kiosk

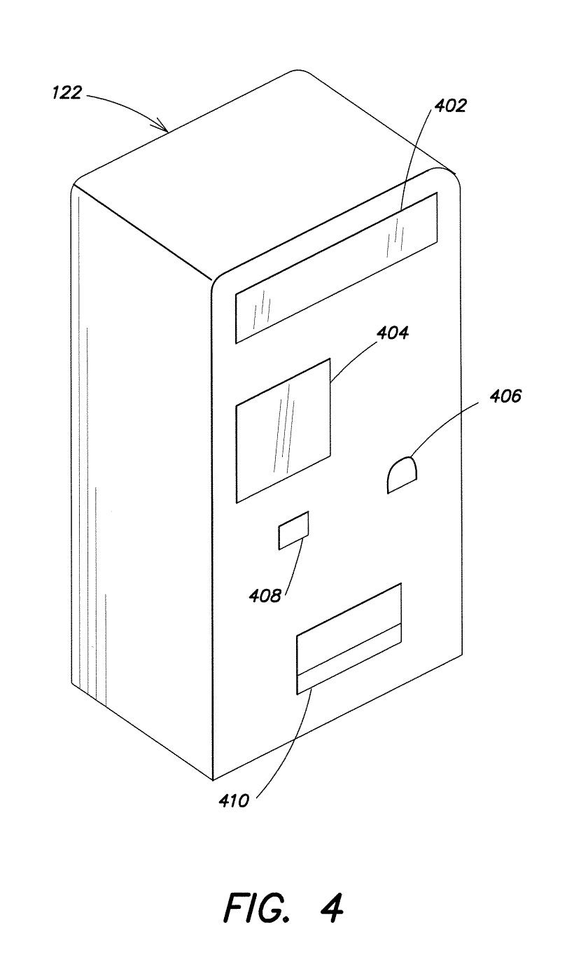

FIG. 4 shows an exemplary implementation of the kiosk 122 shown in FIG. 1. The kiosk 122 comprises a ticker display 402, touch screen display 404, tag scanner 406, receipt printer 408, and bag and tag dispenser 410. The ticker display 402 may display information such as a number of goods recycled, an environmental impact of goods recycled, a welcome message, or the like. The touch screen display 404 may display the electronic interface discussed in the section above. The tag scanner 406 may read information identifying a consumer's account, such as a barcode (or other code) on a conventional wallet-sized card, a keychain card or tag, paper, or computing device display (e.g., smart phone). The information may alternatively be embodied in other forms, such as an RFID tag. Scanning the information identifying the consumer's account allows the consumer's account information to be accessed and displayed on the touch screen display 404. A password may optionally be required to ensure that the individual scanning a tag or the like is the actual consumer or another authorized individual. The receipt printer 408 may print account balance information, coupons, environmental impact information, or any combination of this information or other information. Finally, the bag and tag dispenser 410 may dispense bags or other receptacles that are used by consumers to receive recyclable goods and deposit them at the collection station. According to some embodiments, the bags may be color-coded or otherwise coded to identify a category of goods they are to be used for. The bags may be printed with consumer identification information (e.g., a barcode). Alternatively, a sticker or tag may be affixed to the bag that includes such consumer identification information. Such stickers or tags may also be dispensed by the bag and tag dispenser.

FIG. 5 illustrates in block diagram form a non-limiting example of a computer system which may be implemented as the kiosk 122, the computing system 126, or the computing device 128, e.g., any one of those items may have the structure illustrated in FIG. 5. As shown, the computing system 500 includes input device(s) 502, output device(s) 501, processor 503, memory system 504 and storage 506 (e.g., a storage device or other suitable storage), all of which are coupled, directly or indirectly, via interconnection mechanism 505, which may comprise one or more buses or switches. The input device(s) 502 receive input from a user or machine (a human operator) and the output device(s) 501 display(s) or transmit(s) information to a user or a machine (e.g., a liquid crystal display). Other componentry and configurations may be used for a computing system, as that shown in FIG. 5 is a non-limiting example.

### Benefits to Recycling Program Participants

Recycling programs according to aspects of the present application provide numerous potential benefits to the participants, i.e., the consumer, retailer, vendor(s) and administrator(s). Some exemplary, non-limiting benefits are discussed below.

The consumer receives value for their recycling efforts in the form of coupons. In addition, the recycling program is an easy and straightforward solution that allows the consumer to help the environment with reduced confusion and low effort. The consumer may also better appreciate the personal impact of his/her recycling and apply recycling efforts to fund organizations (e.g., community groups and schools).

The retailer may benefit by supporting a program that promotes recycling growth. In addition, the retailer may increase traffic to retail store(s) as a result of retailer-specific coupons that can be used only for retailer purchases and as a result of their proximity to the collection station where consumers deposit recyclables.

The vendors may benefit because consumers are incentivized to buy vendor goods that can be recycled for value and/or are environmentally friendly (e.g., 100% recyclable). Further, purchases may be increased via the use of vendor-specific coupons. The vendors may also benefit from the generation of additional recycled raw materials (e.g., recycled food grade PET) via the recycling program that can be used as feedstock for new containers and consumables.

The administrator(s) may benefit by receiving compensation from the sale of raw recycled materials. In addition, the administrator(s) may receive compensation through advertising (e.g., at the kiosk, on their web site, and/or at the collection location). Such advertising may comprise acknowledgement of vendor participation in the recycling program, for example.

### CONCLUSION

The computing system(s) 126, computing device 128 and kiosk 122 of FIG. 1 may comprise at least one processor (e.g., a general-purpose processor, controller, or microcontroller device), at least one memory (e.g., any volatile or non-volatile data storage device, such as, but not limited to, a random access memory (RAM) device and a removable memory device (e.g., a universal serial bus (USB) flash drive)), and/or a communication interface. The communication interface may be any wired and/or wireless communication interface for connecting to a network and by which information (e.g., the contents of memory) may be exchanged with other devices connected to the network. Examples of wired communication interfaces may include, but are not limited to, USB protocols, RS232 protocol, RS422 protocol, IEEE 1394 protocol, Ethernet protocols, and any combinations thereof. Examples of wireless communication interfaces may include, but are not limited to, an Intranet connection; an Internet connection; radio frequency (RF) technology, such as, but not limited to, Bluetooth®, ZigBee®, Wi-Fi, Wi-Max, IEEE 802.11; and any cellular protocols; Infrared Data Association (IrDA) compatible protocols; optical protocols (i.e., relating to fiber optics); Local Area Networks (LAN); Wide Area Networks (WAN); Shared Wireless Access Protocol (SWAP); any combinations thereof; and other types of wireless networking protocols.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Some embodiments may be implemented at least in part by a computer comprising a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium, or other storage device) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present technology as described above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present application need not reside on a single computer or processor, but may be distributed in a modular fashion amongst a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though described as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A recycling kiosk, comprising:
at least one display configured to display recycling information to a consumer;
at least one input device configured to display a user interface to the consumer and to receive at least one input from the consumer;
at least one reader device configured to read an identifier presented by the consumer;
at least one printer configured to print information related to at least one recycling transaction performed by the consumer; and
at least one processor configured to receive a coupon value limited to purchase of new goods from at least one of one or more consumer product manufacturers, the coupon value having been calculated based on an indication of a quantity of recycled goods produced by at least one of the one or more consumer product manufacturers,
wherein the kiosk is configured to provide the coupon value to the consumer in exchange for the recycled goods produced by at least one of the one or more consumer product manufacturers.

2. The kiosk of claim 1, wherein:
the kiosk is communicatively coupled to at least one computing system configured to calculate the coupon value, and
the at least one processor is configured to receive the coupon value from the at least one computing system.

3. The kiosk of claim 1, wherein:
the kiosk is configured to provide the coupon value by printing a coupon using the at least one printer.

4. The kiosk of claim 1, further comprising:
at least one dispenser configured to dispense at least one receptacle for recycled goods.

5. The kiosk of claim 1, wherein:
the at least one reader device is configured to read a card as the identifier presented by the consumer.
